(19) United States
(12) Patent Application Publication
(10) Pub. No.: US 2008/0052139 A1
(43) Pub. Date: Feb. 28, 2008

(54) EVENT DRIVEN DIAGRAMMING METHOD FOR PROJECT PLANNING

(76) Inventor: Thomas C. Long, Port St. Lucie, FL (US)

Correspondence Address: GRAY ROBINSON, P.A., P.O. Box 2328, FT. LAUDERDALE, FL, 33303-9998, US

(21) Appl. No.: 11/843,854

(22) Filed: Aug. 23, 2007

Related U.S. Application Data
(60) Provisional application No. 60/839,607, filed on Aug. 23, 2006.

(51) Int. Cl. G06Q 10/00

(52) U.S. Cl. 705/7

(57) ABSTRACT

An instantaneous, event driven diagramming method is provided which identifies discrete events within various activities performed during the course of a project and interrelates such events, where applicable, according to the timing and/or functional relationship between such events. An event driven diagram generated in accordance with the method of this invention may be used with CPM, and may be read by a computer employing standard algorithms to determine the critical path of the project.

### CROSS-REFERENCE TO RELATED APPLICATION

This application claims the benefit of U.S. Provisional Application Ser. No. 60/839,607 filed Aug. 23, 2006 under 35 U.S.C. § 119(e) for all commonly disclosed subject matter. U.S. Provisional Application Ser. No. 60/839,607 is expressly incorporated herein by reference in its entirety to form part of the present disclosure.

### FIELD OF THE INVENTION

This invention relates to a diagramming method for portfolio and project management and planning, and, more particularly, to an event driven diagramming method which identifies discrete events within various activities performed during the course of a project and interrelates such events, where applicable, according to the timing and/or functional relationship between such events.

### BACKGROUND OF THE INVENTION

Planning is a critical aspect of projects in the field of construction and a variety of other fields. Projects may have a duration of months or years, and construction contracts for example, often include penalty provisions for delays in the completion of a project which may amount to thousands of dollars per day. Project planners must be able to plan the sequence in which work on the project will be performed, and the rate at which resources should be devoted to any given task to avoid delays. Additionally, the plan must be capable of change in view of unforeseen circumstances such as equipment failure, weather issues, labor strikes and a myriad of other events.

The most commonly used method of modeling the time and criticality of different activities within a project is known as the critical path method or CPM. The CPM method employs a computer algorithm which follows a diagram of every related path in a project through activities, their durations and the relationships between them to determine the longest sequence of activities. The longest sequence of activities is called the “critical path.” A delay in any one of the activities along the critical path results in a delay of the completion date of the overall project.

Historically, two primary methods of project diagramming have been employed with the CPM method. These include the Arrow Diagramming Method or ADM, and the Precedence Diagramming Method or PDM. Referring initially to FIG. 1, a diagram using the ADM method is schematically shown in connection with a road building project. For ease of illustration and discussion, the project is assumed to consist of four activities, namely, clearing and grubbing, excavation, drainage and building the road. In an ADM network, nodes are used and the combination of two nodes denotes a particular activity. Each activity must be defined by a unique pair of nodes. As shown in FIG. 1, there are nodes 1, 2, 3, 4 and 5. Nodes 1 and 2 are connected by line 10 which is indicative of the activity “clearing and grubbing,” and a duration of ten days is attributed to that activity. Nodes 2 and 3 are connected by line 12 and represent the “drainage” activity which is given a duration of eleven days. Nodes 2 and 4, joined by line 14, denote the “excavation” activity, and that is assigned a duration of twelve days. Finally, nodes 4 and 5 are connected by line 16 and represent the “building the road” activity having a duration of nine days.

It is noted from FIG. 1 that the duration of the drainage activity is less than the excavation activity by one day. In order for the computer to follow the diagram from beginning to end along the path encompassing the drainage activity, a line 18 is inserted between nodes 3 and 4 denoting a “dummy” activity. There is no activity represented by line 18 and the node path 3 to 4, and therefore a zero duration is attributed to that node pair. Consequently, a day of “float” or permitted delay is present between the end of the drainage activity and the end of excavation, i.e. it takes five days to complete excavation and only four days for drainage, and therefore drainage can be delayed by one day without affecting the completion date of the project. The total float of any sequence of activities is equal to the amount of time a sequence of activities can be delayed before delaying the completion date of the entire project.

Employing the CPM method with the arrow diagram shown in FIG. 1 it is noted that the “critical path” or longest sequence of activities occurs along the pathway of nodes 1 to 2, 2 to 4 and 4 to 5 for a total of thirty-one days. The other path evident in FIG. 1 is that along nodes 1 to 2, 2 to 3, 3 to 4 and 4 to 5 for a total of thirty days, or one day less than the critical path.

The example depicted in FIG. 1 illustrates the basic premise of arrow diagramming, i.e. a network is established by diagramming activities using pairs of nodes, and relating one activity to another by their starts and finishes. One problem with the ADM method is apparent when it is desired to obtain a more precise model of a project where activities are not related by their starts or finishes. For example, in the example shown in FIG. 1 it is assumed that the drainage and excavation activities do not begin until the end of clearing and grubbing, and that building the roadway does not commence until the drainage and excavation activities have been completed. As a practical matter, a contractor would likely want to begin the drainage and excavation activities at some point after the start of the clearing and grubbing activity but before such activity has been completed. Similarly, building of the road would typically follow the clearing and grubbing, drainage and excavation activities at some point before they are finished. Because the ADM method depends on the use of pairs of nodes to denote a particular activity, when the plan becomes more complicated and one or more activities do not necessarily begin at the start or finish of another activity, a number of dummy nodes or extra activities must be incorporated into the diagram network. This results in a loss of the original activity structure and a great deal of confusion.

The Precedence Diagramming Method or PDM was developed to improve upon ADM diagramming, and is currently the plan diagram most commonly used with the CPM method. Precedence diagramming is predicated upon identifying unique activities and then establishing relationships between the starts or finishes of such activities. Referring now to FIG. 2, the same roadway construction project described in connection with a discussion of FIG. 1 is illustrated with the PDM method. Instead of focusing on the relationships between activities as in the ADM method, the PDM method identifies activities, each having a start and a finish, with an assigned duration for each activity. The clearing and grubbing activity is identified by the box labeled with the reference number 20, with start and finish positions indicated within the box 20 as well as a duration of ten days. The PDM method provides for improved flexibility, compared to the ADM model, and this is demonstrated in FIG. 2 by the introduction of “lag” into the relationships between activities. As noted above, the building contractor may wish to begin the excavation and drainage activities of the road building project before the completion of the clearing and grubbing operation. The “start” of the clearing operation 10 is thus shown in FIG. 2 as being connected by a line 22 to the start of the excavation activity, depicted as box 24, with a positive lag 26 of plus two days interposed between the start of such activities. This indicates to the planner that the excavation activity 24 may “lag” or begin two days after the start of the clearing operation 20.

The other activities of the project are related to one another, e.g. start-to-start, start-to-finish, finish-to-finish or finish-to-start, in a similar manner. The drainage activity, indicated by box 28, is connected by a line 30 to the start of the clearing and grubbing activity 20 with a positive lag 32 of plus four days between the start of same. The duration of the excavation activity 24 and drainage activity 28 are shown in their respective boxes. The finish of the excavation activity 24 and finish of the drainage activity 28 are associated with the start of the road building activity, identified by reference number 34 in FIG. 2. The finish of the excavation activity 24 is connected to the start of the road building activity 34 by a line 36 with a negative lag 38 of minus three days between the two, and the finish of the drainage activity 28 is connected by a line 40 to the start of the road building activity 34 with a negative lag 42 of three days between them. The “negative” lag in this context means that the road building activity 34 may start three days prior to the finish of the excavation and drainage activities, 24 and 28, respectively, as distinguished from a “positive” lag wherein the start of an activity must follow another activity such as described above. The finish of the excavation activity 24 and the drainage activity 28 are connected to the finish of the road building activity 34 via lines 46 and 48, respectively. The finish of the clearing and grubbing activity 20 is connected to the finish of excavation 24 by line 50 and to the finish of drainage 28 by line 52.

While the PDM method adds some degree of clarity compared to the ADM method, the planner is still left to guess about a number of things. There is no indication in the PDM network of what the lags 26, 32, 38 and 42 represent. Further, there is no indication of what events take place within a given activity, how the duration of an activity is determined and/or what is the duration between events within an activity.

Another significant limitation of both the ADM and PDM methods involves determining the status of a particular project at a selected point in time. The road construction project discussed as an example above is very simple and of limited duration. Many projects, however, may comprise hundreds of activities and take months or years to complete. It is desirable to determine the status of the critical path on a regular basis to identify problem areas which could impact the completion date of the project, and allow planners to allocate materials and manpower accordingly. Complicated projects of relatively long duration typically employ “data dates,” often once a month, at which time a “snapshot” is taken of the status of currently pending activities of the project. This snapshot involves obtaining a percentage completion date on each of the pending activities from the contractor(s) in charge of the project. In other words, the contractor must provide his best estimate of how far along each currently active activity is toward completion, on a percentage basis, as of the data date. Percentage completion dates are inherently subjective and are difficult to accurately estimate which can lead to appreciable error in the ensuing calculation of the critical path. Moreover, it is not uncommon for the actual calculation of the critical path based on percentage completion dates to take several weeks to perform, at which time the project has moved forward for that amount of time and the critical path calculation is dated and of questionable value.

### SUMMARY OF THE INVENTION

This invention is directed to an instantaneous, event driven diagramming method which identifies discrete point-in-time events within various activities performed during the course of a project and interrelates such events, where applicable, according to the timing and/or functional relationship between such events. An event driven diagram generated in accordance with the method of this invention may be used with CPM, and may be read by a computer employing standard algorithms to determine the critical path of the project.

The event driven diagramming method of this invention is predicated on the observation that it is not necessarily the start or finish of one activity that relates to the start or finish of another activity. Rather, it is the discrete events within activities, and/or when such events occur, that relate to discrete events within another activity. As described in detail below, in the diagramming method of this invention each event is identified by a description of that event appearing within a “box” in a diagram. Events are related to one another in the sense that one event follows another, and the relationship between related events is represented by a line connecting the two in the diagramming method herein. Each event does not have a duration in and of itself, but represents an instantaneous point in time. As such, the boxes which identify each event are not assigned a duration. Instead, the durations are assigned to the relationships between events, and the durations between given events represent the amount of time it takes from the instantaneous point-int-time of one event to the instantaneous point-in-time of a succeeding event. The duration of any particular activity within a project is the aggregate of the durations between the discrete events within that activity.

Once discrete events are identified within the various activities of a project, it is the pathway through these events, and the duration of the relationships between them, that determines when activities become critical. Unlike prior ADM or PDM diagramming methods, the event driven method of this invention identifies, instantaneously, at what event an activity will become critical or not critical. Some activities may become critical or not critical after they start or before they finish, depending upon such factors as delay or acceleration in the completion dates of their discrete events.

Updating the event driven network of this invention can follow two paths. Only currently active activities and relationships create an impact to the critical path. When a delay or acceleration occurs, it is recorded for the day it occurs. The duration between the events impacted by the delay or acceleration is modified accordingly when a computer, employing a conventional CPM algorithm, reaches this date. The project is updated each day with the subject diagramming method, with a record of cumulative losses and gains in time, and their causes. Secondly, with respect to revisions to the plan, all revisions are accompanied by an inception date. When the CPM algorithm reaches the inception date, it revises the schedule accordingly and continues on with the calculation of critical path. Losses or gains due to revisions are quantified and separated from those due to progress.

The progress of any activity using the method of this invention is determined by whether or not the events within that activity have taken place or not. Unlike the highly subjective percent completion method of determining the status of a project employed in the ADM and PDM methods discussed above, the completion date of an event involves an objective determination on the part of the scheduler. An event has either occurred or it has not. The guesswork of whether an activity is 20% completed or 80% completed is eliminated from the method of this invention. This removes the need for having artificially established data dates, noted above, where a snapshot of the progress of various current activities of a project is taken in order to attempt to ascertain whether or not the project is on schedule. Consequently, schedules can be continuous through time with the method of this invention and updated instantaneously on the basis of whether events have taken place, and, if so, at what time. The planner and contractor are not limited to a separate schedule with each data date update, but rather can have one schedule continuously updated while retaining all of the detail of the history of the project pertaining to time lost or gained up to the last update or revision.

Among the important purposes of obtaining updates of the project during its execution is to permit contractors to know where to best place their resources, and project managers to know what is impeding or accelerating progress. The percent completion and data date approach employed in the prior art is not only subjective but in most instances results in the provision of information which is too dated to be of much use. The event driven diagramming method of this invention, by providing for one continuous schedule, dramatically improves the information available to contractors and program managers, in terms of accuracy, clarity and timing. Data is available on a real time basis, and there is no guesswork involved in determining whether an event within an activity is completed or not. As such, trends in the schedule and forecasts can be assessed with the method herein prior to their impact on the overall project.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a flow chart diagram of a road building project using the prior art Arrow Diagramming Method;

FIG. 2 is a flow chart diagram of a road building project using the prior art Precedence Diagramming Method; and

FIG. 3 is a flow chart diagram of a road building project using the event driven diagramming method of this invention

### DETAILED DESCRIPTION OF THE INVENTION

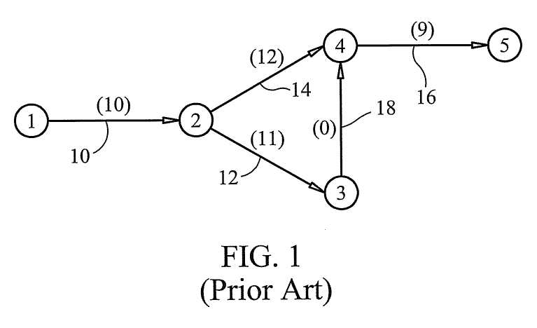

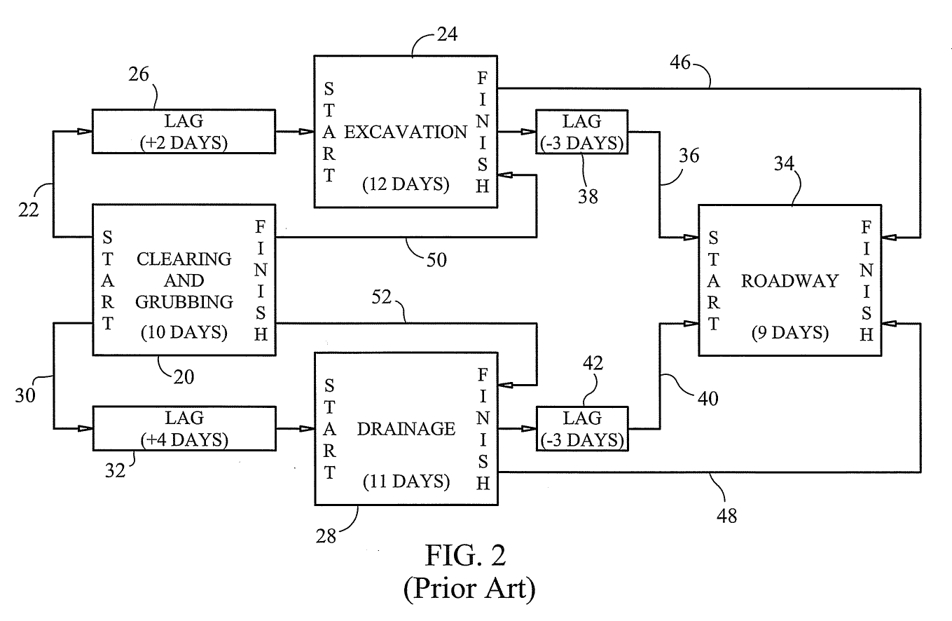

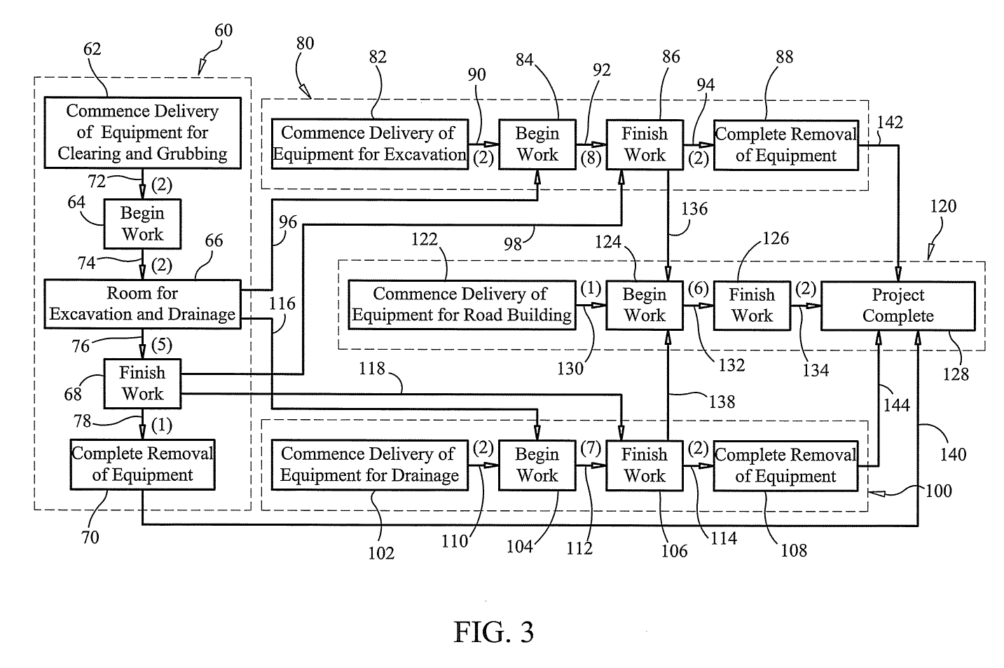

The prior art Arrow Diagramming Method and Precedence Diagramming Method have been described above in connection with a discussion of FIGS. 1 and 2, respectively. Referring now to FIG. 3, the event driven diagramming method according to this invention is illustrated using the same road building example as in FIGS. 1 and 2. It should be understood that the road building example is intended for purposes of illustration only, and the method of this invention can be employed with a variety of different projects, construction or otherwise, having essentially any level of complexity.

As noted above, the initial task in diagramming a project with the method of this invention is to identify the different activities to be undertaken during the course of a project, and then to list the events within each activity which will take place from the start of such activity to its completion. Each event must be uniquely identified. In the road building example, there are four activities, namely, clearing and grubbing, excavation, drainage and road building. Each of these activities, and the point-in-time events within them, are described separately below.

The clearing and grubbing activity is identified by the box 60, depicted in phantom lines in FIG. 3. This activity comprises a number of discrete events, each denoted by a separate box. These events include box 62 denoting “commence delivery of equipment for clearing and grubbing,” box 64 for “begin work,” box 66 for “room for excavation and drainage,” box 68 for “finish work,” and box 70 for “complete removal of equipment.” As discussed above, the descriptive notations contained in the boxes 62-70, and the diagramming method of this invention, define each event in terms of an instantaneous point in time. There is an instantaneous point in time at which the event “commence delivery of equipment for clearing and grubbing” 62 takes place. The boxes 62-70 are connected by lines for purposes of illustrating the relationship between events, i.e. one event succeeds another event. A duration is assigned to the relationship between events, as represented in FIG. 3 by a number next to each line, but the events themselves are not given a duration in the diagramming method herein.

In the particular example of this invention illustrated in FIG. 3, a line 72 extends between box 62 and 64 which is labeled with the number “2.” This denotes that according to the project plan it will take two days from the “commence delivery of equipment for clearing and grubbing” event 62 until the “begin work” event 64 occurs. The event represented by box 62 is not given a duration. Instead, the relationship between the event represented by box 62 and the event represented by the related, succeeding event denoted by box 64 has a duration of “2” days in this example.

Line 74 between box 64 and 66 refers to a time period, marked with the number “2” after which work on clearing and grubbing has progressed to a point where there is “room for excavation and drainage” as depicted in box 66. An important conceptual aspect of the method of this invention is predicated upon the realization that in project planning the start of one activity is not necessarily related to the start or finish of another activity, and one or more events within a given activity may be related not only functionally to an event in another activity but temporally. Box 66 is a good example of this aspect of the present invention. It is recognized by the contractor that after two days of clearing and grubbing, enough “room” or physical space has been cleared to allow excavation and drainage to begin in the area which has been cleared. There is no functional relationship between clearing and grubbing, and excavation or drainage as such, e.g. in the sense that the same equipment, for example, is used to perform these activities. However, these activities are related to one another temporally, and the event “room for excavation and drainage” 66 is a “trigger” or starting point in time for the beginning of work event in excavation and beginning of work event in drainage, as discussed below. The method of this invention has the capability of visually depicting this relationship in a diagram, and also linking the trigger event (room for excavation and drainage) to events (begin work) in other activities (excavation and drainage). Neither of the prior art diagramming methods described above has this capability, or anything remotely like it. As noted above, the PDM method for example, is based on start-to-start, start-to-finish, finish-to-start or finish-to-finish relationships. In order to represent the “room for excavation and drainage” function and relate it to excavation and drainage in the PDM method, the clearing and grubbing activity would have to be linked to the excavation and drainage activities with a “lag” inserted to account for the start of such activities before the completion of the clearing and grubbing activity. One reading such PDM diagram would have no idea what this lag represents, or the events within either clearing and grubbing, excavation or drainage that such lag relates to. This is a serious deficiency of prior art diagramming methods which is solved by the present invention.

Continuing within the clearing and grubbing activity 60, the room for excavation and drainage box 66 is connected by a line 76 to the finish work box 68 with a duration of 5 days given to the relationship between those two events. The relationship between the finish work event 68 and the complete removal of equipment event 70 is represented by line 78 and is given a duration of one day. It should be understood that the events depicted in the clearing and grubbing activity 60 are intended for purposes of illustration and there could be more events depending upon circumstances. For example, after the commencement of work on clearing and grubbing an unforeseen event could arise that creates a delay, e.g. repair or replacement of damaged or defective equipment, an encounter with rock or other unexpected obstacle which delays clearing, etc. These situations may be added to the clearing and grubbing activity 60 as discrete events identified by their own box, with an assigned duration to a succeeding event, on the day they occur. Such an update may or may not affect the critical path but the method of this invention allows that to be determined on a continuous basis, e.g. every day as a result of the addition of such event(s). A particular activity may become critical during its performance, where at the inception of the project such activity may not be considered critical, but the method of this invention allows that determination to be made on a continuous basis. Consequently, the contractor has the opportunity to reallocate resources to take care of the problem on a timely basis before it does become critical, i.e. affects the overall completion date of the project.

Referring now to the top of FIG. 3, the dotted line box 80 represents the excavation activity of the road building project. This activity begins with a “commence delivery of equipment for excavation” event depicted as box 82, and includes a “begin work” event identified as box 84, a “finish work” event denoted by box 86 and a “complete removal of equipment” event shown as box 88. It is noted that many of the events within the excavation activity 80 have the same name as those in the clearing and grubbing activity 60. This is permissible so long as each event is given a unique identity. That is accomplished by identifying the events as being associated with a particular activity; hence, the structure of the diagram illustrated in FIG. 3 with separate boxes for each activity. Boxes 82 and 84 are connected by a line 90 assigned a duration of “2” days, a line 92 connects boxes 84 and 86 with a duration of “8” days and line 94 connects boxes 86 and 88 with a duration of “2” days. The lines 90-94 are intended to signify the relationships between events 82-88 in terms of time and sequence, and the durations of such relationships, in the same manner as described above in connection with a discussion of the clearing and grubbing activity 60.

As noted above, there is a temporal relationship between the “room for excavation and drainage” event 66 of the clearing and grubbing activity 60 and the excavation activity 80. This relationship is depicted by a line 96 which connects event box 66 with the “begin work” event 84 of the excavation activity 80. These two events are not related to one another functionally, but temporally, i.e. at the time the “room for excavation and drainage” event 66 within the clearing and grubbing activity 60 occurs, then the work may begin in excavation (box 84). The event driven diagram of this invention clearly identifies this relationship, making it easy for one reading it to determine the sequence of events and the relationship between them. There is no “trigger” as such for the delivery of equipment event 82 in the excavation activity 80, but it is clearly identified in the diagram and is noted by the computer reading the diagram. Additionally, the “finish work” box 68 of the clearing and grubbing activity 60 is connected by a line 98 to the “finish work” box 86 of the excavation activity 80.

Referring now to the bottom of FIG. 3, the dotted line box 100 represents the drainage activity of the road building project. This activity 100 has essentially the same nominal events as the excavation activity 80 described above. The drainage activity 100 begins with a “commence delivery of equipment for drainage” event depicted as box 102, and includes a “begin work” event identified as box 104, a “finish work” event denoted by box 106 and a “complete removal of equipment” event shown as box 108. All of these events 102-108 have the same name as those in the excavation activity 80, but are given a unique identity as being associated with the drainage activity 100. Boxes 102 and 104 are connected by a line 110 assigned a duration of “2” days, a line 112 connects boxes 104 and 106 with a duration of “7” days and line 114 connects boxes 106 and 108 with a duration of “2” days. The lines 110-114 are intended to signify the relationships between events 102-108 in terms of time and sequence, and the durations of such relationships, in the same manner as described above in connection with a discussion of the clearing and grubbing activity 60. Just as with the excavation activity 80, and for the same purpose as described above, there is a temporal relationship between the “room for excavation and drainage” event 66 of the clearing and grubbing activity 60 and the drainage activity 100. This relationship is depicted by a line 116 which connects event box 66 with the “begin work” event 104 of the excavation activity 80. Additionally, the “finish work” box 68 of the clearing and grubbing activity 60 is connected by a line 118 to the “finish work” box 106 of the excavation activity 100.

Finally, the road building activity is shown in the dotted line box 120 in the center of FIG. 3. The road building activity 120 has essentially the same nominal events as the excavation activity 80 and drainage activity 100 described above. The road building activity 120 begins with a “commence delivery of equipment for road building” event depicted as box 122, and has a “begin work” event identified as box 124, a “finish work” event denoted by box 126 and a “project complete” event shown as box 128. While many of these events have the same names as those in the excavation activity 80 and drainage activity 100, they are given a unique identity as being associated with the road building activity 120. Boxes 122 and 124 are connected by a line 130 assigned a duration of “1” day, a line 132 connects boxes 124 and 126 with a duration of “6” days and line 134 connects boxes 126 and 128 with a duration of “2” days. The lines 130-134 are intended to signify the relationships between events 122-128 in terms of time and sequence, and the durations of such relationships, in the same manner as described above in connection with a discussion of the other activities 60, 80 and 100.

A “trigger” or temporal relationship exists between the “finish work” events 86, 106 of the excavation and drainage activities 80, 100, respectively, and the “begin work” event of the road building activity 124. The project planning calls for the road building work to begin after the completion of the excavation and drainage work. To signify this temporal relationship in the diagram, the finish work event 86 of the excavation activity 80 is connected by a line 136 to the begin work event 124 of the road building activity 120, and a line 138 connects the finish work event 106 of the drainage activity 100 with such begin work event 124. The “complete removal of equipment” events 70, 88 and 108 of the clearing and grubbing activity 60, excavation activity 80 and drainage activity 100, respectively, are connected by respective lines 140, 142 and 144 to the project complete event 128 of the road building activity to denote completion of the entire project.

Throughout the duration of the project, each discrete event in all of the activities is represented as “open” or “completed.” There is no provision for the highly subjective “percent completed” designations employed in prior art diagramming methods. For example, either the commence delivery of equipment event for clearing and grubbing denoted by box 62 has taken place, or it has not, and an objective determination can be made of that fact one way or the other. Data is entered on a daily basis to indicate whether each currently active event is still open or has been completed, and this enables the project to be essentially continuously updated throughout its duration.

As discussed above, each of the events in the project must be uniquely identified. The diagramming method of this invention is intended to be used with software capable of interfacing with CPM algorithms. One way of uniquely identifying each event within the project is to provide a library of events and a separate listing of the activities for a particular project within the software. The diagram is constructed by assigning particular events from the library of events to each activity. For example, a “begin work” event is identified in the library of events and assigned as depicted by box 64 to the clearing and grubbing activity 60. Although the “begin work” event from the library will also be used in the excavation, drainage and road building activities 80, 100 and 120, respectively, each one of these “begin work” events is uniquely identified in those activities, e.g. by boxes 84, 104 and 124, because it is assigned from the library to a different activity. In this manner, a library of events may be constructed with many “generic” or often used events, but when assigned to a particular activity each such event is uniquely identified. This feature of the present invention greatly simplifies and expedites diagramming of a project plan.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof.

For example, it is noted above that each event within all activities must be uniquely identified. In the simplified example of road building discussed above, events in different activities are the same but no event within the same activity is repeated. A complicated construction project may have hundreds of activities and many events within separate activities that are nominally the same, e.g., “pouring of concrete,” for example. It is nevertheless contemplated that each “pouring of concrete” event can be uniquely identified as required in the method herein such as by referencing the location or structure of the concrete pour.

Therefore, it is intended that the invention not be limited to the particular embodiment disclosed as the best mode contemplated for carrying out this invention, but that the invention will include all embodiments falling within the scope of the appended claims.

What is claimed is:

1. A diagramming method for project planning, comprising:
(a) identifying activities which need to be carried out to complete a project;
(b) assigning discrete events to each activity in such a way that each event in the project is uniquely identified;
(c) relating each event to at least one other event, and assigning a duration to the relationship between related events.

2. The method of claim 1 in which step (b) comprises:
(i) providing a library of events;
(ii) providing a listing of activities for the project;
(iii) assigning at least one event from said library of events to each of said activities, the combination of said at least one event with a particular activity creating a unique identification for said at least one event.

3. The method of claim 1 in which each of said events is representative of an instantaneous point in time.

4. The method of claim 1 in which step (c) comprises relating each event to a succeeding event.

5. The method of claim 4 in which step (c) comprises assigning a duration to the relationship between successive events.

6. A diagramming method for project planning, comprising:
(a) identifying activities which need to be carried out to complete a project;
(b) assigning discrete events to each activity in such a way that each event in the project is uniquely identified;
(c) relating each event within each activity to at least one other event in said activity, and assigning a duration to the relationship between related events;
(d) interrelating an event from one activity with an event from another activity.

7. The diagramming method of claim 6 in which step (b) comprises updating the assignment of discrete events during the course of the project within one or more activities to account for occurrences which were initially unplanned.

8. The diagramming method of claim 6 in which step (c) comprises assigning a duration to the relationship between each updated event added in step (b) and a related event within said one or more activities.

9. The diagramming method of claim 6 in which step (d) expresses the interrelationship of events within different activities on the basis of the time at which they occur within the project regardless of whether or not said events are otherwise related to one another.

10. The diagramming method of claim 6 in which step (c) comprises assigning an updated duration to the relationship between related events which are subject to a delay and recording the occurrence of said delay on a periodic basis.

11. The diagramming method of claim 10 in which step (c) comprises assigning an updated duration to the relationship between related events which are subject to an acceleration and recording the occurrence of said acceleration on a periodic basis.

12. The diagramming method of claim 11 in which step (c) comprises recording the cumulative losses due to delays and the cumulative gains due to acceleration on a periodic basis.

13. The diagramming method of claim 6 in which step (c) comprises assigning an updated duration the relationship between related events which are subject to a revision of the plan.

14. The diagramming method of claim 13 in which step (c) comprises recording an inception date for each of said events which is subject to said revision of the plan.

15. The diagramming method of claim 14 in which step (c) comprises separating the cumulative total of said updated duration between related events which are subject to a revision of the plan from a cumulative total of updated durations between related events which are subject to a delay or to an acceleration.

16. The diagramming method of claim 6 in which at least some of said events are active at a given point in time and at least some of said events are not active at said given point in time, said diagramming method further including step (e) comprising recording the occurrence of active events as they become completed on the day said occurrence takes place.

17. The method of claim 6 in which step (b) comprises:
(i) providing a library of events;
(ii) providing a listing of activities for the project;
(iii) assigning at least one event from said library of events to each of said activities, the combination of said at least one event with a particular activity creating a unique identification for said at least one event.

18. The diagramming method for project planning, comprising:
(a) identifying activities which need to be carried out to complete a project;
(b) assigning discrete events to each activity in such a way that each event in the project is uniquely defined;
(c) relating each event within each activity to at least one other event in said activity, and assigning a duration to the relationship between related events;
(d) interrelating the occurrence of an event from one activity with the occurrence of an event from another activity;
(e) expressing when each event within each activity has occurred, whereby the critical path of the project may be calculated on a continuous basis as the project progresses.

19. The diagramming method of claim 18 in which step (b) comprises updating the assignment of discrete events during the course of the project within one or more activities to account for occurrences which were initially unplanned.

20. The diagramming method of claim 18 in which step (c) comprises assigning a duration to the relationship between each updated event added in step (b) and a related event within said one or more activities.

21. The diagramming method of claim 18 in which step (d) expresses the interrelationship of events within different activities on the basis of the time at which they occur within the project regardless of whether or not said events are otherwise related to one another.

22. The diagramming method of claim 18 in which step (c) comprises assigning an updated duration to the relationship between related events which are subject to a delay and recording the occurrence of said delay on a periodic basis.

23. The diagramming method of claim 22 in which step (c) comprises assigning an updated duration to the relationship between related events which are subject to an acceleration, and recording the occurrence of said acceleration on a periodic basis.

24. The diagramming method of claim 23 in which step (c) comprises recording the cumulative losses due to delays and the cumulative gains due to acceleration on a periodic basis.

25. The diagramming method of claim 18 in which step (c) comprises assigning an updated duration to the relationship between related events which are subject to a revision of the plan.

26. The diagramming method of claim 25 in which step (c) comprises recording an inception date for each of said events which is subject to said revision of the plan.

27. The diagramming method of claim 26 in which step (c) comprises separating the cumulative total of said updated duration between related events which are subject to a revision of the plan from a cumulative total of updated durations between related events which are subject to a delay or to an acceleration.

28. The method of claim 18 in which step (b) comprises:
(i) providing a library of events;
(ii) providing a listing of activities for the project;
(iii) assigning at least one event from said library of events to each of said activities, the combination of said at least one event with a particular activity creating a unique identification for said at least one event.
